(19) United States
(12) Patent Application Publication
(10) Pub. No.: US 2016/0208908 A1
(43) Pub. Date: Jul. 21, 2016

(54) TRANSMISSION DRIVE DEVICE AND COMFORT DRIVE FOR A MOTOR VEHICLE

(71) Applicant: Robert Bosch GmbH, Stuttgart (DE)

(72) Inventors: Thomas Huck, Rheinmuenster (DE); Franz Tasch, Rheinstetten (DE); Andreas Wehrle, Durbach (DE)

(21) Appl. No.: 14/912,140

(22) PCT Filed: Aug. 5, 2014
(86) PCT No.: PCT/EP2014/066765

§ 371 Date: Feb. 15, 2016

(30) Foreign Application Priority Data
Aug. 14, 2013 (DE) 10 2013 216 130.1

(51) Int. Cl. F16H 57/12; F16H 57/039; F16H 1/16; F16H 57/022

(52) U.S. Cl. CPC F16H 57/12; F16H 57/022; F16H 57/039; F16H 1/16; F16H 2057/0221; F16H 2057/0213

(57) ABSTRACT

The invention relates to a transmission drive device (10) comprising a shaft (14; 14a) which is arranged in a housing (12) in a longitudinally movable manner in the direction of the shaft axis (26) and comprising a shaft end (15; 15a) which is formed on an end face and which is supported at least indirectly on the housing (12) via at least one starting element (30). Either the shaft end (15) or the starting element (30) has a rounded design at least in some regions, a bearing point (31) being formed between the starting element (30) and the shaft end (15; 15a), and the starting element (30) being coupled to a damping element (32; 32a to 32d) which allows a movement of the starting element (30) in the event of an axial application of force (F_{A}, F_{A1}, F_{A2}) by means of the shaft (14; 14a). According to the invention, the starting element (30) and/or the damping element (32; 32a to 32d) is/are designed and/or arranged such that the distance (r) of the bearing point (31) to the longitudinal axis (26) of the shaft (14; 14a) increases as the axial application of force (F_{A}, F_{A1}, F_{A2}) increases at least starting from a specified level of the application of force (F_{A}, F_{A1}, FA₂).

### BACKGROUND OF THE INVENTION

The invention relates to a transmission drive device. Furthermore, the invention relates to a comfort drive for a motor vehicle using a transmission drive device according to the invention.

A transmission drive device is known from the applicant's DE 10 2006 061 700 A1. The known transmission drive device is used in a comfort drive of a motor vehicle, for example in a power window drive, a seat adjustment drive, a sliding roof drive or the like. It is a requirement of a transmission drive device of this type that the latter remains in its position under a defined load when at a standstill in order to avoid an undesirable adjustment of the element to be adjusted (i.e. the window, the sliding roof, the seat or the like). When at a standstill, the electric drive of the transmission drive device is switched into the currentless state. The greatest portion of the locking is produced here via the transmission stage or, in the event of multi-stage transmissions, via the transmission stages. The required locking in the transmission makes it necessary that, for the operation of the transmission drive device, that is to say for adjusting the window, the sliding roof, the seat or the like, use has to be made of a relatively powerful electric drive in order initially to be able to overcome the locking. With better efficiency of the transmission, the required power demand or the overall size of the electric drive of the transmission drive device can be reduced, which leads, inter alia, in a desired manner to a lighter and more compact transmission drive device. Nevertheless, the transmission drive device has to produce the desired locking when at a standstill.

For this purpose, it is known, in the case of the document mentioned at the beginning, that a shaft end of spherical design bears against a starting element which, in turn, is supported in a transmission housing via a damping element. In this case, the starting element, which is designed in the form of a starting plate, is arranged at an oblique angle with respect to the longitudinal axis of the shaft. Furthermore, it is mentioned in the known document that, when axial impacts occur along the longitudinal axis of the starting element, both the starting element and the damping means can be adjusted axially along a guide rail, which is likewise arranged at the oblique angle mentioned. By means of a device of this type, when axial forces occur on the shaft, caused by a torque introduced into the transmission drive device by the element to be adjusted, a counterforce which is at least approximately linearly dependent, depending on the axial force, and which brings about the self-locking can be produced. By contrast, the design of a transmission drive device is desirable in which there is only very slight self-locking, if any at all, when relatively small axial forces, if any at all, occur on the shaft, while, as the axial force on the shaft increases, a superproportionally increasing counterforce is desirable for producing a likewise superproportionally increasing self-locking. As a result, use can be made in the driving situation of a driving motor which is particularly lightweight or has a particularly low driving power and which, in conjunction with a transmission having relatively high efficiency, permits a particularly lightweight or compactly constructed transmission drive device.

### SUMMARY OF THE INVENTION

Taking the depicted prior art as the starting point, the invention is based on the object of developing a transmission drive device in such a manner that self-locking which increases superproportionally with increasing axial force on the shaft and which opposes a rotation of the shaft can be produced. As a result, a particularly lightweight and compactly constructed transmission drive device can be realized.

This object is achieved according to the invention in the case of a transmission drive device in that the starting element and/or the damping element are/is designed and/or arranged in such a manner that, as the axial application of force on the shaft increases, the bearing point between the starting element and the shaft end is at an increasing distance from the longitudinal axis of the shaft, at least from a certain level of the application of force. A design of this type makes it possible for a force which increases superproportionally with the axial application of force on the shaft and which opposes the rotation of the shaft to be produced since the friction force arising between the shaft and the bearing point of the shaft end is produced from the sum of the force acting in the longitudinal direction of the shaft and the moment of friction produced depending on the distance of the bearing point from the longitudinal axis of the shaft. In addition, a transverse force component which is directed perpendicularly to the longitudinal axis of the shaft and which, in the case of radial bearings, leads to increased friction in the bearings, which likewise increases the self-locking, is also produced.

In order to realize an increase in distance of the bearing point from the longitudinal axis of the shaft, it is proposed, in a preferred refinement of the invention, that the starting element is designed to be tiltable about an axis arranged at a distance from the longitudinal axis of the shaft.

The damping element serves in particular for reducing noise when switching over the direction of rotation of the driving motor of the transmission drive device on account of the play, which is present in particular because of manufacturing tolerances, between the individual components. In order to reduce the wear of the transmission drive device when axial forces occur on the shaft, it is provided that the damping element is arranged on that side of the starting element which faces away from the shaft end, and therefore the starting element (which is composed, for example, of a particularly low-wear material) is in contact with the shaft end.

In a specific refinement for realizing the tilting movement, it is proposed that the starting element has a bearing surface which is designed, from a certain application of force, to bear at least in regions against a positionally fixed mating element such that the starting element is tiltable about an axis formed by the bearing surface. This means, conversely, that if the starting element is not yet tilted, the bearing point between the shaft end and starting element is located in particular in the longitudinal axis of the shaft, and therefore the discussed superproportional increase in the self-locking takes place only from a certain point or certain axial force on the shaft, while, in the case of smaller axial forces, an at least approximately linear increase in the self-locking is obtained.

In a structurally preferred refinement for absorbing the forces acting on the starting element from the shaft, it is proposed that the starting element is arranged in a torsion proof manner in the housing by means of at least one bearing surface which bears against a mating surface in the housing.

In order to ensure a positionally correct installation of the starting element in the housing, it is furthermore advantageous if the starting element has a positioning element for the positionally correct installation in the housing.

In order to avoid damage, for example to the damping element or the starting element, in the event of particularly high axial forces on the shaft, it can be provided that the starting element has a stop surface for limiting the tilting angle of the starting element.

The connection between the starting element and the damping element takes place at least via a form-fitting connection. A form-fitting connection of this type can exist, for example, by means of a corresponding dimensional toleration between the damping element, which is customarily composed of rubber, and the starting element, and therefore a clamping connection is formed between the two mentioned elements, the clamping connection securely holding the two parts together. For this case, it is customarily not required to provide an additional connection, for example an adhesive connection or another mechanical connection.

The damping element is preferably designed in the form of a preferably rotationally symmetrical body composed of rubber. A particularly simple and cost-effective manufacturing of the damping element can thereby be obtained.

The invention also comprises a comfort drive in a motor vehicle, such as a power window drive, a seat adjustment drive, a sliding roof drive or the like with a drive device according to the invention.

### BRIEF DESCRIPTION OF THE DRAWINGS

Further advantages, features and details of the invention emerge from the description below of preferred exemplary embodiments and with reference to the drawing, in which:

FIG. 1 shows a longitudinal section through a partial region of a transmission drive device according to the invention,

FIG. 2 shows the transmission drive device according to FIG. 1 in a partially sectioned top view,

FIG. 3 shows parts of the transmission drive device according to FIGS. 1 and 2 in an individual illustration in order to clarify the operative principle of a starting element and a damping element,

FIG. 4 shows a first embodiment of a damping element and a starting element in a perspective view,

FIG. 5 shows the elements according to FIG. 4 in the fitted state in a perspective view,

FIG. 6 shows a damping element and starting element modified in relation to FIG. 4, in a perspective view,

FIG. 7 shows the elements according to FIG. 6 in the mounted state, in a perspective view,

FIG. 8 and FIG. 9 show a detail of FIG. 2 in an enlarged illustration for clarifying the manner of operation of the damping element and of the starting element at different axial loadings of an armature shaft,

FIG. 10 and FIG. 11 show a modified embodiment of the invention at different positions of the armature shaft, in each case in longitudinal section,

FIG. 12 shows parts of the arrangement according to FIG. 10 with a modified armature shaft and a modified starting element in a partially sectioned side view,

FIG. 13 and FIG. 14 show a further modified embodiment of the invention at different positions of the armature shaft, in each case in longitudinal section,

FIG. 15 and FIG. 16 show, in side view and top view, a starting element as used in the device according to FIGS. 13 and 14, and

FIG. 17 and FIG. 18 show a further modified embodiment of the invention using a starting disk as starting element, at different positions of the armature shaft, in each case in longitudinal section.

Identical elements or elements with the same function are provided with the same reference signs in the figures.

### DETAILED DESCRIPTION

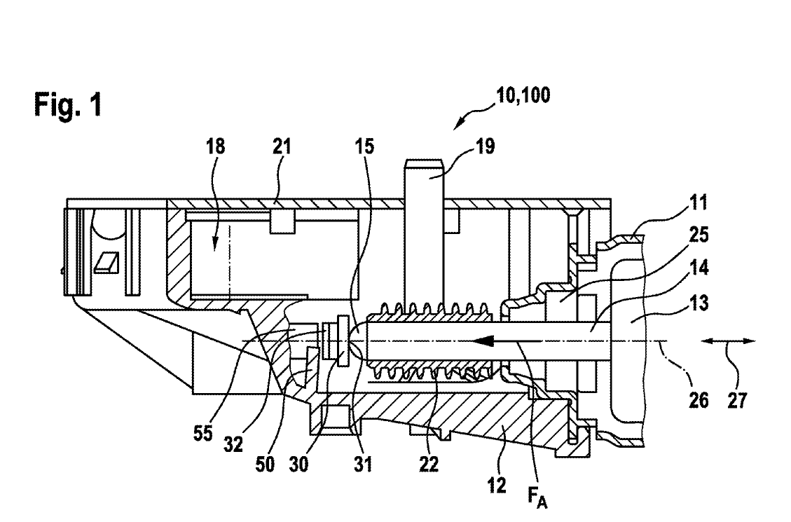

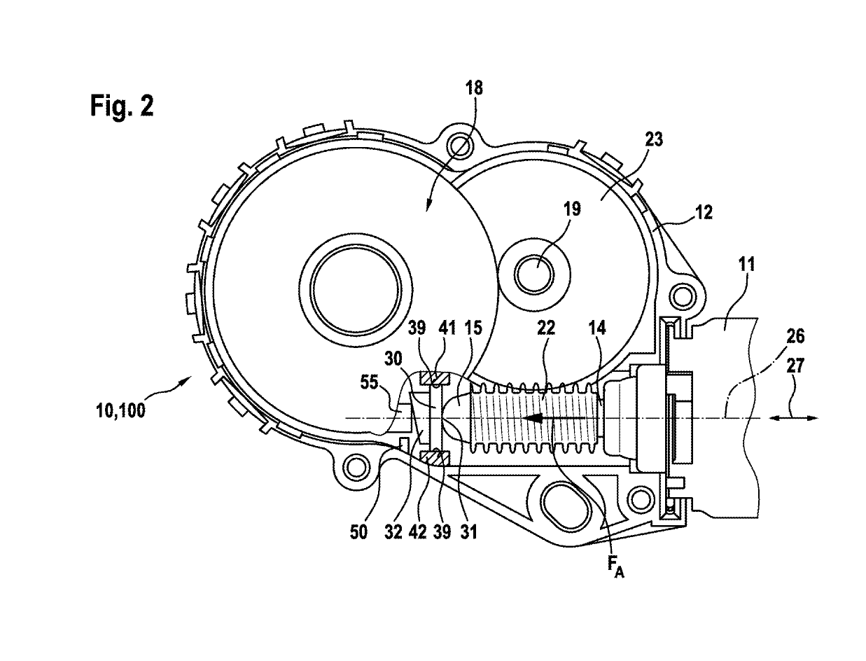

The transmission drive device 10 illustrated in FIGS. 1 and 2 is part of a comfort drive 100 in a motor vehicle. Within the context of the invention, a comfort drive 100 is understood by way of example, but not in a restricting manner, as meaning a power window drive, a seat adjustment drive, a sliding roof drive or the like.

The transmission drive device 10 comprises a driving motor (not illustrated specifically) which is designed as an electric motor and the motor housing or pole pot housing 11 of which is flange-mounted onto a transmission housing 12. An armature 13 is arranged within the pole pot housing 11, the armature shaft 14 of which armature projects with the spherically, that is to say rounded shaft end 15 thereof into the transmission housing 12.

A single- or multi-stage transmission 18, the output shaft 19 of which projects out of the upper side of a transmission cover 21, which is part of the transmission housing 12, is arranged in the transmission housing 12. The transmission 18 serves for reducing the rotational speed of the electric motor while simultaneously increasing the torque thereof. For this purpose, the armature shaft 14 within the transmission housing 12 has a partial section with a worm toothing 22 which meshes with a corresponding mating toothing on a gear wheel which is designed as a spur gear 23 and is mounted rotatably within the transmission housing 12. That section of the output shaft 19 which projects out of the transmission housing 12 is connected at least indirectly to the element to be adjusted, i.e., for example, to a window or a sliding roof.

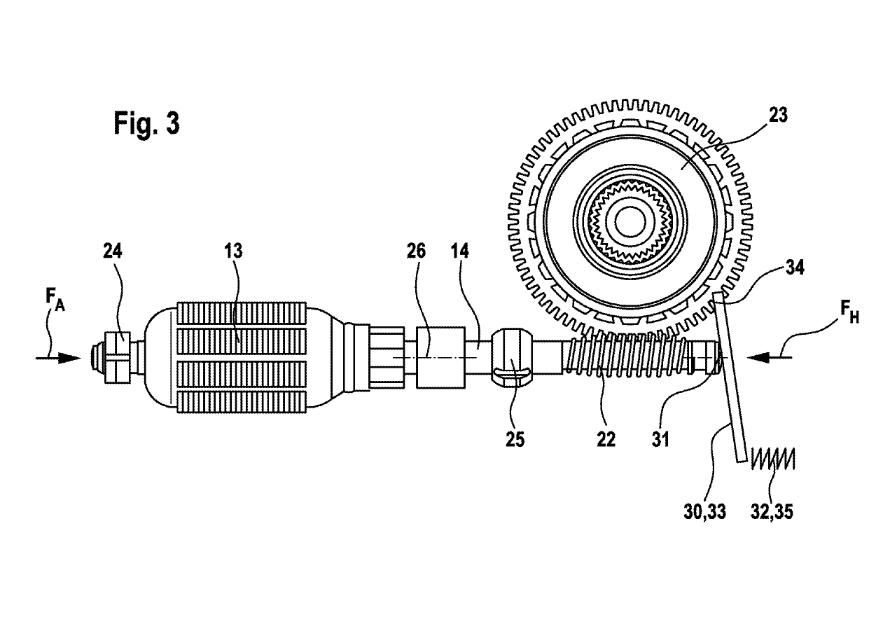

According to the illustration of FIG. 3, the armature shaft 14 is mounted radially at least in two bearings 24, 25, wherein the first bearing 24 is located in the region of the pole pot housing 11 on that side of the armature 13 which faces away from the transmission housing 12. The other bearing 25 is arranged between the region of the worm toothing 22 and the armature 13. It is essential that the two bearings 24, 25 are designed only for absorbing radial forces acting on the armature shaft 14, but cannot absorb any axial forces which act in the direction of the longitudinal axis 26 of the armature shaft 14. Axial forces of this type acting in the direction of the double arrow 27 are in particular transmitted to the armature shaft 14 if a load is introduced into the transmission 18 via the output shaft 19 from the element to be adjusted (window, sliding roof, etc.) when the transmission drive device 10 is switched into the currentless state.

It is mentioned in addition that it does, of course, lie within the scope of the invention to use more than two bearings 24, 25.

According to the invention, the spherically designed shaft end 15 of the armature shaft 14 touches a starting element 30 at a bearing point 31. The starting element 30 is arranged in turn on the side facing away from the shaft end 15 in operative connection with a damping element 32. The combination of the starting element 30 and the damping element 32 serves to produce a locking moment or self-locking depending on the axial forces FA introduced into the armature shaft 14 in the direction of the starting element 30, which opposes rotation of the transmission wheels of the transmission 18 or of the output shaft 19.

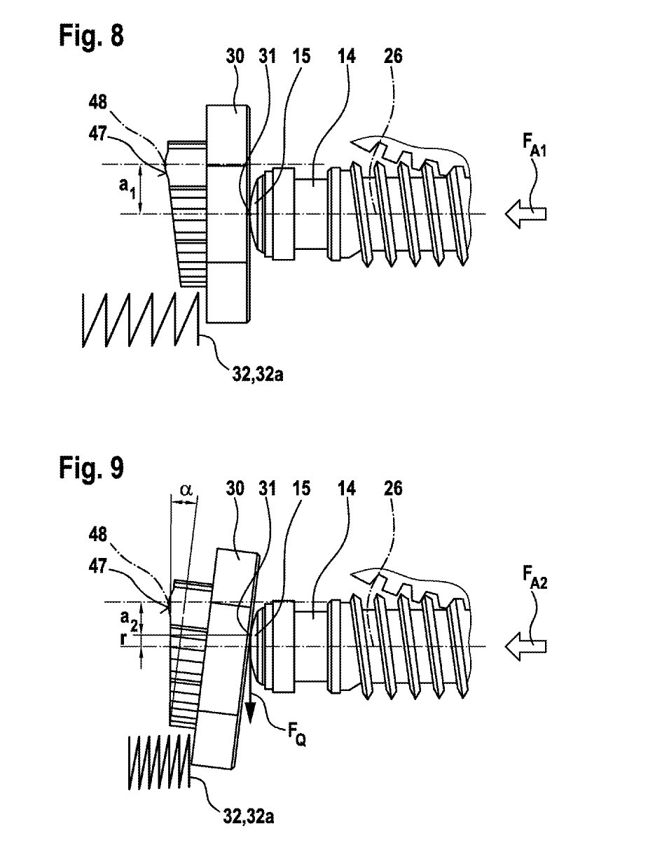

The operative principle of the starting element 30 and of the damping element 23 is clarified below with reference to FIG. 3, wherein, in the exemplary embodiment illustrated in FIG. 3, the starting element 30 is designed as a starting plate 33 which is arranged tiltably or pivotably in a tilting axis 34, which runs perpendicular to the plane of projection of FIG. 3, in the transmission housing 12 in a manner not illustrated. On that side of the bearing plate 33 which is opposite the tilting axis 34, said bearing plate is arranged in operative connection to a damping element 32, which is designed as a compression spring 35. If an axial force FA is exerted on the armature shaft 14 in the direction of the bearing plate 33, the bearing point 31, which runs in the longitudinal axis 26 of the armature shaft 14 if an axial force FA is not present or is small, migrates in the direction of the tilting axis 34 in accordance with the deflection of the bearing plate 33 about the tilting axis 34 such that a distance r which is greater as the axial force FA increases is formed between the longitudinal axis 26 and the bearing point 31, as can also be seen particularly clearly from FIGS. 8 and 9. A counterforce FH is produced here on the shaft end 15 or the armature shaft 14 from the bearing plate 33, said counterforce being all the more greater, the larger the radius r is. In particular, the reaction force which leads to the self-locking of the transmission 18 increases superproportionally to the axial force FA as a consequence of the larger radius r with the greater axial force FA.

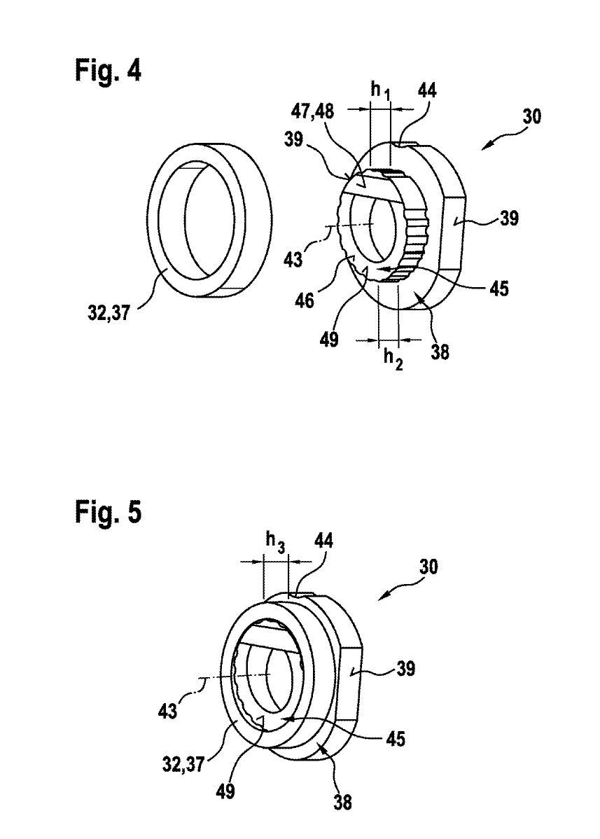

In the case of the damping element 32 illustrated in FIGS. 4 and 5, said damping element is produced from an elastic material, in particular from rubber, and is designed in the form of a ring 37. The starting element 30 has a plate-like section 38 which is provided with a respective flattened portion 39 on mutually opposite sides. According to FIG. 2, the plate-like section 38 of the starting element 30 is accommodated in a form-fitting manner with the two flattened portions 39 thereof between the bearing surfaces of two housing-mounted guide elements 41, 42, and therefore the starting element 30 cannot rotate about the longitudinal axis 43 thereof. The plate-like section 38 has, on an upper side, by way of example, a notch 44 which serves as a positioning element and serves for the positionally correct installation of the starting element 30 by, for example, a corresponding mating element on the transmission cover 21 interacting with the notch 44, and therefore the installation of the transmission cover 21 is permitted only in one position.

On the side facing away from the shaft end 15, the plate-like section 38 has an annular section 45 which has an obliquely arranged end side 46 with respect to the longitudinal axis 43 of the starting element 30. The height h1 on that side of the annular section 45 which faces the notch 44 is thus greater than the height h2 on the side facing away from the notch 44. In the region of the end side 46 which lies on the side facing the notch 44, the end side 46 has a bearing surface 47 which is oriented perpendicularly to the flattened portions 39 and forms a tilting axis 48. According to the illustration of FIG. 5, the ring 37 has a height h3 which approximately corresponds to the height h1 of the section 45 or is somewhat greater than the height h1. Furthermore, the inside diameter of the ring 37 is adapted to the outside diameter of the annular section 45 in such a manner that, when the ring 37 is mounted on the annular section 45, a form-fitting connection in the form of a clamping connection is formed between the ring 37 and the bearing element 30. On the side opposite the bearing surface 47, the end side 46 forms a stop surface 49 which limits the tilting angle α, about which the starting element 30 can be pivoted with the damping element 32, by bearing against at least one housing-mounted stop element 50, which can be seen in FIGS. 1 and 2. The tilting of the starting element 30 takes place as soon as the latter bears with the bearing surface 47 thereof after compression of the damping element 32, which bears against a positionally fixed mating element (not shown) on the end side facing away from the starting element 30, against a mating element 55 which is likewise arranged in a positionally fixed manner in the transmission housing 12 and can be seen in FIGS. 1 and 2.

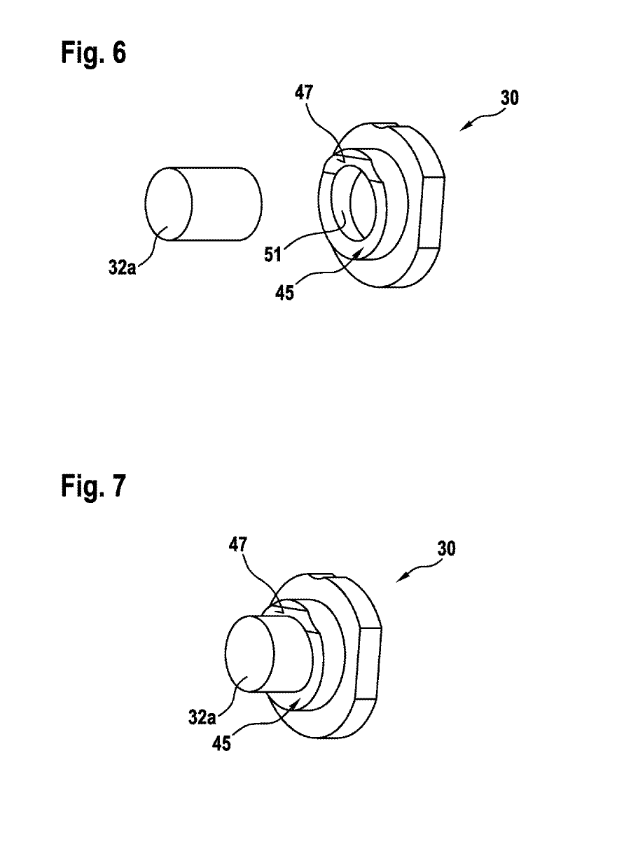

The damping element 32a which can be seen in FIGS. 6 and 7 differs from the damping element 32 in that said damping element 32a is designed as a cylindrical damping element 32a which can be introduced into the opening 51 in the annular section 45 of the starting element 30 forming a clamping connection. The damping element 32a projects out of the opening 51 and in particular also protrudes over the bearing surface 47 in the axial direction.

In FIGS. 8 and 9, the manner of operation of the starting element 30 in conjunction with the damping elements 32, 32a, which are depicted as spring elements, is explained: in FIG. 8, an axial force FA1, which brings about a compression of the damping element 32, 32a, acts on the armature shaft 14 in such a manner that the bearing surface 47 is not yet operatively connected to the housing-mounted stop element 50 (not illustrated). The tilting angle α is therefore 0°. Nonetheless, a counterforce is produced by the starting element 30 in the direction of the shaft end 15, said counterforce being dependent on the friction values between the shaft end 15 and the starting element 30. Furthermore, it is seen that the bearing point 31 is aligned with the longitudinal axis 26 of the armature shaft 14, and therefore a distance a1 arises between the tilting axis 48 and the bearing point 31 or a distance r of zero arises between the longitudinal axis 26 of the armature shaft 14 and the bearing point 31.

In FIG. 9, an axial force FA2 which is greater than the axial force FA1 in FIG. 8 acts on the armature shaft 14. In particular, the axial force FA2 is of a size that the bearing surface 47 of the starting element 30 is operatively connected to the housing-mounted stop element 50, and therefore a tilting of the starting element 30 by the tilting angle α about the tilting axis 48 has taken place. Furthermore, it is seen that the bearing point 31 is no longer aligned with the longitudinal axis 26 of the armature shaft 14, but rather is at a distance a2 from the tilting axis 50, which distance is smaller than the distance a1 in FIG. 8, or that a distance r is produced between the longitudinal axis 26 of the armature shaft 14 and the bearing point 31. Said reduced distance a2 or the (increased) distance r brings about a superproportional increase of the reaction force of the starting element 30 on the armature shaft 14 by means of a moment of friction, and therefore the level of the self-locking is also superproportionally greater than in FIG. 8. Furthermore, a transverse force component FQ, which is arranged perpendicularly to the longitudinal axis 26 of the armature shaft 14, is produced at bearing point 31, said transverse force component producing a radial loading of the bearings 24, 25 and therefore likewise producing increased friction of the armature shaft 14 in the bearings 24, 25.

It is mentioned in addition that, in the exemplary embodiment illustrated, a starting element 30 is arranged or provided only on one shaft end 15. If it is also intended for axial forces FA which act on the armature shaft 14 not in the direction of the starting element 30, but rather counter to the starting element 30, to lead to self-locking of the transmission 18, it is required also to provide the other shaft end (not illustrated in the figures) with a corresponding starting element 30 and with a damping element 32, 32a.

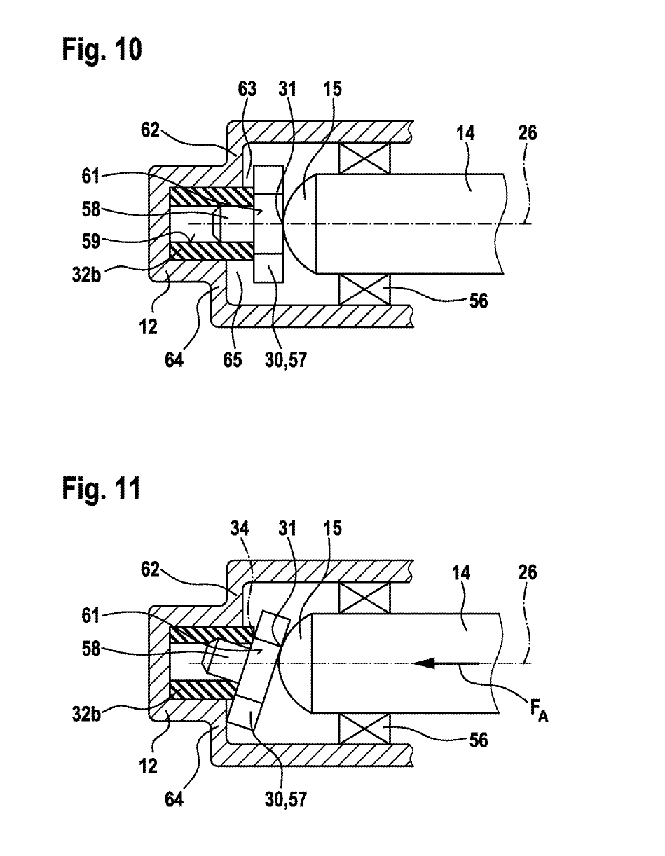

FIGS. 10 and 11 illustrate part of a modified transmission drive device 10. The armature shaft 14 which is mounted in a radial bearing 56 is seen in a region, for example of the transmission housing 12, having a reduced cross section. The spherically designed shaft end 15 interacts with a starting element 30 which is designed as a starting disk 57 and projects with a pin-shaped extension 58 for guiding and positioning the starting disk 57 into a passage opening 59 of the damping element 32b. The arrangement of the damping element 32b with the longitudinal axis thereof is aligned with the longitudinal axis 26 of the armature shaft 14. The starting disk 57 has a respective flattened portion 61 on two opposite sides running parallel to the plane of projection of FIGS. 10 and 11, the flattened portion interacting with the transmission housing 12 or with a respective side wall of the transmission housing 12, in order to form a means of securing the starting disk 57 against torsion. In the unloaded state of the armature shaft 14, the starting disk 57 has a gap 63 from a first end wall 62 of the transmission housing 12, but, in a modification of the exemplary embodiment illustrated, said gap may also be zero (in the event of a shorter damping element 32b). On that side of the starting disk 57 which is opposite the gap 63, a second gap 65 which is larger than the gap 63 is formed between the starting disk 57 and an axially set-back second end wall 64. In the event of axial loading of the armature shaft 14 by the axial force FA according to FIG. 11, the shaft end 15 of the armature shaft 14 presses against the starting disk 57, wherein the bearing point 31 of the shaft end 15 migrates outward on the starting disk 57 from the position (illustrated in FIG. 10) in alignment with the longitudinal axis 26, with a distance r being formed. It is also essential here that the starting disk 57 tilts about its tilting axis 34, which runs perpendicularly to the plane of projection of FIG. 11, at the latest when the starting disk 57 bears against the first end wall 62. Furthermore, the second end wall 64, as can be seen in FIG. 11, forms a housing-mounted stop for limiting the tilting angle α of the starting disk 57.

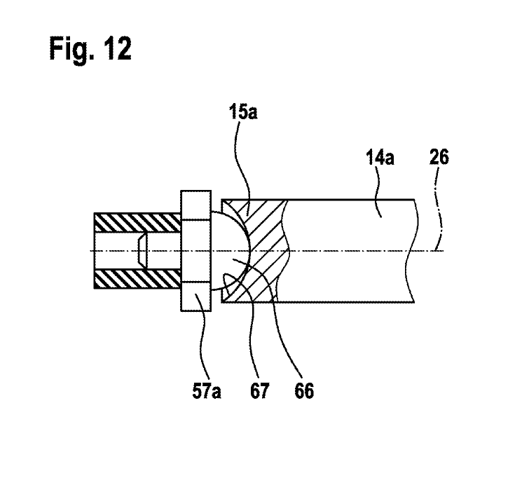

The modified exemplary embodiment in FIG. 12 shows a starting disk 57a as starting element 30 with an end region 66 formed spherically or in the shape of a section of a ball with respect to the armature shaft 14a. The end region 66 runs on a concavely formed recess 67 of the shaft end 15a of the armature shaft 14a.

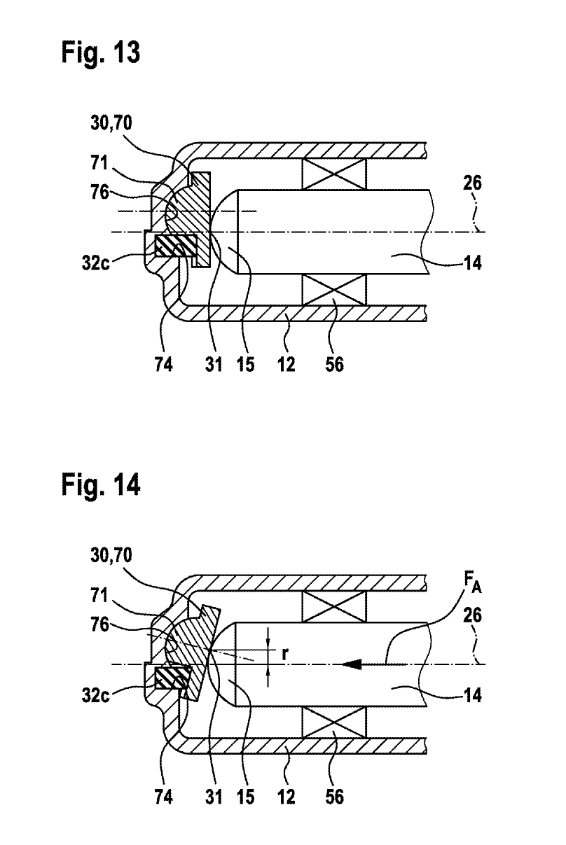

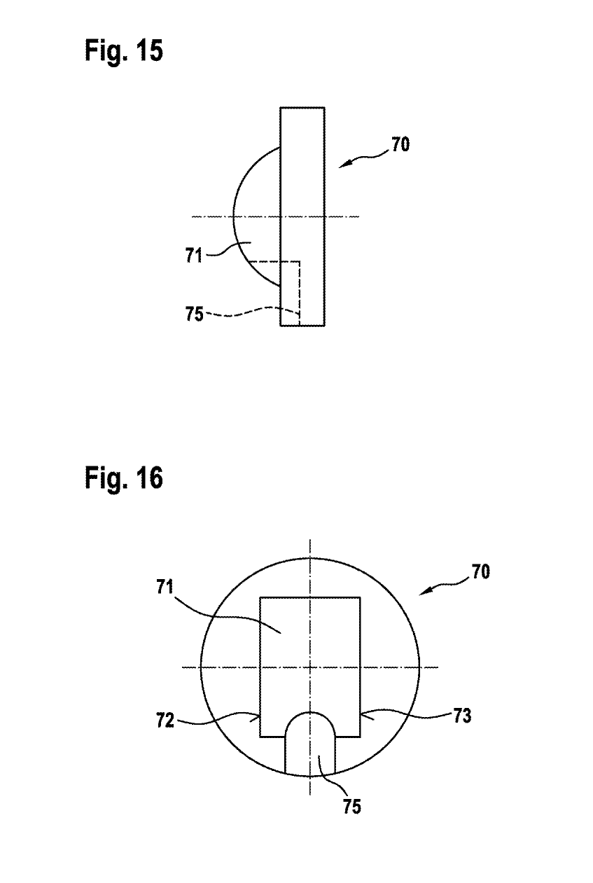

FIGS. 13 to 16 illustrate a further modified transmission drive device 10 with a starting disk 70 as starting element 30, said starting disk having, on the side facing the transmission housing 12, a continuation 71 of rounded design with two side surfaces 72, 73 arranged parallel to each other (FIG. 16). The side surfaces 72, 73 bear in a form-fitting manner against boundaries or walls (not illustrated) of the transmission housing 12 in order to form a means of securing the starting disk 70 against torsion. Furthermore, a recess 74 for the form-fitting accommodating of the damping element 32c is arranged in the transmission housing 12 on that side of the starting disk 72 which faces the transmission housing 12. On the side facing the starting disk 70, the damping element 32c rests in regions in a further recess 75 of the starting disk 70. It is essential that, when the armature shaft is unloaded, according to the illustration of FIG. 13, the bearing point 31 between the armature shaft 14 or the shaft end 15 of the armature shaft 14 and the starting disk 70 is aligned with the longitudinal axis 26 of the armature shaft 14. In the event of axial loading of the armature shaft 14 according to FIG. 14 with an axial force FA, the starting disk 70 pivots within a concave receptacle 76 formed in the transmission housing 12, wherein the bearing point 31 migrates upward from the longitudinal axis 26 in the plane of projection of FIG. 14, with a distance r being formed. Furthermore, FIG. 14 illustrates the maximum tilting angle α of the starting disk 70, in which the starting disk 70 bears against the transmission housing 12 on the side facing the damping element 32c.

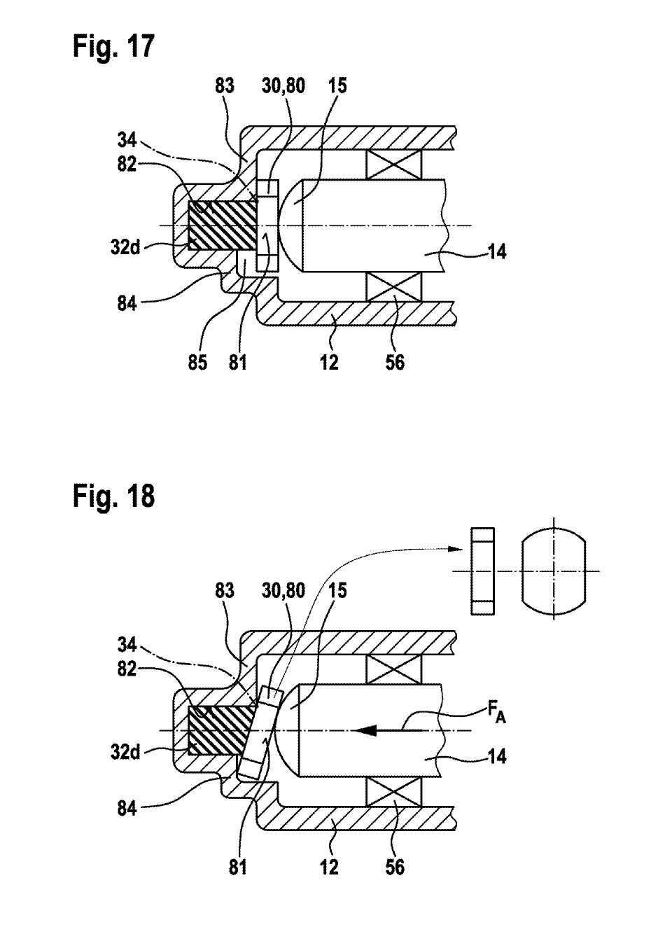

Finally, FIGS. 17 and 18 illustrate a further embodiment of the invention in which a starting disk 80 has as starting element 30 two flattened portions 81 which are arranged parallel to the plane of projection of FIGS. 17 and 18 and which, in analogy to the flattened portions 61, bear in a form-fitting manner against sections of the transmission housing 12 to form a means of securing the starting disk 80 against torsion. The damping element 32d is accommodated in a receptacle 82 of the transmission housing 12 and, in the unloaded state of the armature shaft 14, ends flush with a first end wall 83 of the transmission housing 12. In the unloaded state of the armature shaft 14, a gap 85 from a second end wall 84 is formed between the starting disk 80 and the transmission housing 12 on the side opposite the first end wall 83. In the unloaded state of the armature shaft 14, the starting disk 80 is held by a clamping connection between the damping element 32d and the spherical shaft end 15 of the armature shaft 14. In the event of an axial loading of the armature shaft 14 by an axial force FA, according to the illustration of FIG. 18, the starting disk 80 tilts about its tilting axis 34 (transition of the end wall 83 to the receptacle 82) until the maximum tilting angle α is reached, with the starting disk 80 bearing against the second end wall 84.

It is furthermore mentioned that the transmission drive device 10 described to this extent can be modified in diverse ways without departing from the context of the invention. In particular, it can be provided in all of the embodiments that the starting element 30 can be of rounded or spherical design in order to form a punctiform bearing against the shaft end 15. In this case, the shaft end 15 is preferably, but not in a restrictive manner, provided with a flat bearing surface.

1. A transmission drive device (10), comprising a shaft (14; 14a) which is arranged in a longitudinally displaceable manner in a direction of a longitudinal axis (26) thereof in a housing (12), with a shaft end (15; 15a) which is formed on an end side and is supported at least indirectly on the housing (12) via at least one starting element (30), wherein one of the shaft end (15) and the starting element (30) is of rounded design at least in regions, wherein a bearing point (31) is formed between the starting element (30) and the shaft end (15; 15a), and wherein the starting element (30) is coupled to a damping element (32; 32a to 32d) which permits a movement of the starting element (30) in the event of an axial application of force (F_{A}, F_{A1}, F_{A2}) by the shaft (14; 14a), characterized in that at least one of the starting element (30) and the damping element (32; 32a to 32d) is configured such that, as the axial application of force (F_{A}, F_{A1}, F_{A2}) increases, the bearing point (31) is at an increasing distance (r) from the longitudinal axis (26) of the shaft (14; 14a), at least from a certain level of the application of force (F_{A}, F_{A1}, F_{A2}).

2. The transmission drive device as claimed in claim 1, characterized in that the starting element (30) is tiltable about an axis (34) arranged at a distance (a₁) from the longitudinal axis (26) of the shaft (14; 14a).

3. The transmission drive device as claimed in claim 1, characterized in that the damping element (32; 32a to 32d) is arranged on a side of the starting element (30) which faces away from the shaft end (15; 15a).

4. The transmission drive device as claimed in claim 2, characterized in that the starting element (30) has a bearing surface (47) which is configured, from a certain application of force (F_{A}, F_{A1}, F_{A2}), to bear at least in regions against a positionally fixed mating element (55; 64; 84) such that the starting element (30) is tiltable about the axis (34) formed on the bearing surface (47).

5. The transmission drive device as claimed in claim 1, characterized in that the starting element (30) is arranged in a torsion proof manner in the housing (12) by at least one bearing surface (39; 61; 72, 73; 81) which bears against a mating surface (41, 42) in the housing (12).

6. The transmission drive device as claimed in claim 1, characterized in that the starting element (30) has a positioning element (44) for positionally correct installation in the housing (12).

7. The transmission drive device as claimed in claim 2, characterized in that the starting element (30) has a stop surface (49) for limiting a tilting angle (α) of the starting element (30) about a tilting axis (34).

8. The transmission drive device as claimed in claim 1, characterized in that the damping element (32; 32a; 32b) is connected to the starting element (30) at least via a form-fitting connection.

9. The transmission drive device as claimed in claim 1, characterized in that the damping element (32; 32a to 32d) composed of rubber.

10. A comfort drive (100) in a motor vehicle, with a transmission drive device (10) as claimed in claim 1.

11. The transmission drive device as claimed in claim 1, characterized in that the damping element (32c; 32d) is accommodated in a receptacle (74; 82) in the housing (12).

12. The transmission drive device as claimed in claim 1, characterized in that the damping element (32; 32a to 32d) is a rotationally symmetrical body composed of rubber.
